(19) United States
(12) Patent Application Publication
(10) Pub. No.: US 2016/0050854 A1
(43) Pub. Date: Feb. 25, 2016

(54) MOVABLE HEAT APPLICATOR FOR PROVIDING THERMOTHERAPY TO TREES

(71) Applicant: AG Harvesters, LLC, Au Gres, MI (US)

(72) Inventors: Daniel Minor, Cadillac, MI (US); Todd Carlson, Rochester Hills, MI (US); Brandon Schnettler, Au Gres, MI (US); Andrew Smolen, Au Gres, MI (US); Brittany Harden, Marne, MI (US); Mark Brosky, Tawas City, MI (US); Anthony Brosky, Canton, MI (US); Peter Ravenna, Northville, MI (US)

(21) Appl. No.: 14/832,645

(22) Filed: Aug. 21, 2015

Related U.S. Application Data
(60) Provisional application No. 62/040,532, filed on Aug. 22, 2014.

(51) Int. Cl. A01G 7/06; A01G 1/00

(52) U.S. Cl. CPC A01G 7/06; A01G 1/001

(57) ABSTRACT

A movable heat applicator is provided that is configured to treat a citrus tree for a bacterial disease. The heat applicator includes a heat containment structure that at least partially enclose a citrus tree. A steam generator adapted to produce steam is provided to release steam at a desired pressure and temperature for treating the citrus tree. A steam dispenser is connected to the steam generator and may be arranged in the interior of the heat containment structure at a positioned to dispense steam below branches of the citrus tree. The steam is dispensed into the heat containment structure to create a steam heated treatment environment to treat the bacterial disease. The movable heat applicator may also include a chassis coupled with the heat containment structure and a drivetrain that supports the chassis over a ground surface for moving the containment structure.

### CROSS-REFERENCE TO RELATED APPLICATIONS

The present application claims benefit under 35 U.S.C. §119(e) of U.S. Provisional Application Ser. No. 62/040,532, entitled STEAM APPLICATOR FOR TREES, filed Aug. 22, 2014, which is hereby incorporated herein by reference in its entirety.

### STATEMENT OF FEDERALLY SPONSORED RESEARCH OR DEVELOPMENT

This invention was made with government support under grant number 15-8130-0487-CA, awarded by the U.S. Department of Agriculture. The government has certain rights in the invention.

### FIELD OF THE INVENTION

The present invention generally relates to the field of agricultural thermotherapy machines, and more particularly to portable machines or devices that operate to deliver heat to live trees or other living plants for treating bacterial disease.

### BACKGROUND OF THE INVENTION

Trees are commercially grown in the U.S. and other countries for the harvest of fruit, nuts, and the like. Citrus trees grown in commercial groves can include, for example, orange, grapefruit, lemon, and lime trees.

Citrus trees may become infected with various diseases, such as Huanglongbing (HLB), also referred to as “greening.” HLB is caused by a bacteria that may be transmitted between trees by insects. HLB can affect citrus trees by causing greening and deformation of the fruit, yellowing of leaves, die-back of branches, and ultimate death of the tree. As such, HLB is economically detrimental to commercial citrus groves because, when trees in the grove are infected with HLB, the grove is less productive and requires maintenance associated with replacing infected trees.

There remains a need to efficiently and effectively treat citrus trees that are infected with various diseases, including HLB, to increase the productivity and quality of a grove and to eliminate maintenance associated with caring for and replacing trees infected by disease.

### SUMMARY OF THE INVENTION

The present invention provides a movable heat applicator for providing thermotherapy that is configured to treat a tree, such as a citrus tree, for a bacterial disease, such as HLB. The heat applicator includes a heat containment structure that at least partially encloses a citrus tree and a heat source that is adapted to dispense energy that generates heat in the heat containment structure and thereby creates a treatment environment for reducing bacteria on at least a portion of the citrus tree. For example, the heat source may include a steam generator that is connected to a steam dispenser arranged on the interior of the heat containment structure. In one aspect of the present invention, the heat applicator may be controlled based on a desired characteristic of the treatment environment, such as by a control system that is configured to control the energy dispensed by the energy dispenser to generate heat in the heat containment structure. Also, the heat applicator may include a chassis that supports the heat containment structure and a drivetrain that has at least one driven wheel for rotating a tire or tracks or the like, which operates to move the chassis over a ground surface, such that a control system may also or alternatively control the position of the containment structure relative to the ground surface based on a desired characteristic of the treatment environment.

In another aspect of the present invention, a movable heat applicator for providing thermotherapy includes a heat containment structure having a top cover that is configured to span over an upper portion of a citrus tree and at least one sidewall coupled with the top cover for substantially enclosing a respective side portion of the citrus tree, whereby the heat containment structure is adjustable to increase or decrease an enclosed volume of the heat containment structure. For example, the heat containment structure may include a rigid structural frame and a substantially impermeable panel supported by the structural frame and extending down from opposing sides of the top cover to provide a tunnel with an expandable length extending between front and rear end openings of the tunnel. A movable chassis is coupled with and supports the heat containment structure over a ground surface. Also the movable heat applicator includes a heat source supported by the chassis and configured to generate heat in the enclosed volume of the heat containment structure, thereby creating a treatment environment for diminishing bacteria on at least a portion of the citrus tree. The treatment environment may be configured to have temperature and humidity levels greater than ambient air outside the containment structure, such as a temperature greater than 100 degrees Fahrenheit, and more preferably around 130 degrees Fahrenheit.

In yet another aspect of the present invention, a method for providing thermotherapy that is configured to treat a row of citrus trees in a grove for a bacterial disease includes at least partially enclosing a cavity sized to receive one or more citrus trees with a movable heat containment structure that has at least two opposing sidewalls and a top cover that is adapted to substantially prevent heat from exiting the cavity. Heat is generated in the cavity of the heat containment structure with a movable heat source that is attached to the movable heat containment structure. A treatment environment is created in the cavity with the heat generated by the movable heat source for diminishing bacteria on the citrus tree in the cavity, such that the treatment environment has temperature and humidity levels greater than ambient air outside the containment structure. Conditions of the treatment environment are sensed with a temperature sensor, a humidity sensor, and/or a speed sensor. Based on the sensed conditions of the treatment environment and a desired characteristic of the treatment environment, the energy dispensed to the cavity by the heat source may be controlled, operation of an air agitation unit attached to the heat containment structure may be controlled, operation of a pre-heating energy dispenser configured to pre-heat a portion of a citrus tree may be controlled, and/or a speed of the containment structure relative to the ground surface may be controlled. For example, the desired characteristic of the treatment environment may include exposing each infected citrus tree in the row of citrus trees to a temperature greater than ambient air outside the containment structure.

These and other aspects, objects, and features of the present invention will be understood and appreciated by those skilled in the art upon studying the following specification, claims, and appended drawings.

### BRIEF DESCRIPTION OF THE DRAWINGS

FIG. 1 is a top perspective view of a movable heat applicator, in accordance with the present invention;

FIG. 1A is a top perspective view of the movable heat applicator shown in FIG. 1, having a panel covering provided on a structural frame of a heat containment structure;

FIG. 2 is an end elevation view of the movable heat applicator shown in FIG. 1, illustrating a tree positioned in the heat containment structure;

FIG. 3 is a top plan view of the movable heat applicator shown in FIG. 1, illustrating a tree in a row of trees positioned in the heat containment structure;

FIG. 4 is a top perspective view of a portion of a steam distribution system, including a steam dispenser, of the movable heat applicator shown in FIG. 1;

FIG. 5 is an end elevation view of the illustrated portion of the steam distribution system shown in FIG. 4;

FIG. 6 is a top perspective view of the structural frame of the of the heat containment structure shown in FIG. 1;

FIG. 7 is a top perspective view of a chassis of the movable heat applicator shown in FIG. 1, which illustrates a drivetrain attached to the chassis to move the containment structure relative to a citrus tree;

FIG. 8 is a schematic illustration of a control unit of the heat applicator; and

FIG. 9 is a top perspective view of a movable heat applicator, in accordance with an additional embodiment of the present invention;

FIG. 10 is a top perspective view of a movable heat applicator, in accordance with a further embodiment of the present invention;

FIG. 11 is a top plan view of the movable heat applicator shown in FIG. 10 in a grove of citrus trees; and

FIG. 12 is a top perspective view of a movable heat applicator, in accordance with the embodiment shown in FIG. 10.

### DESCRIPTION OF THE PREFERRED EMBODIMENTS

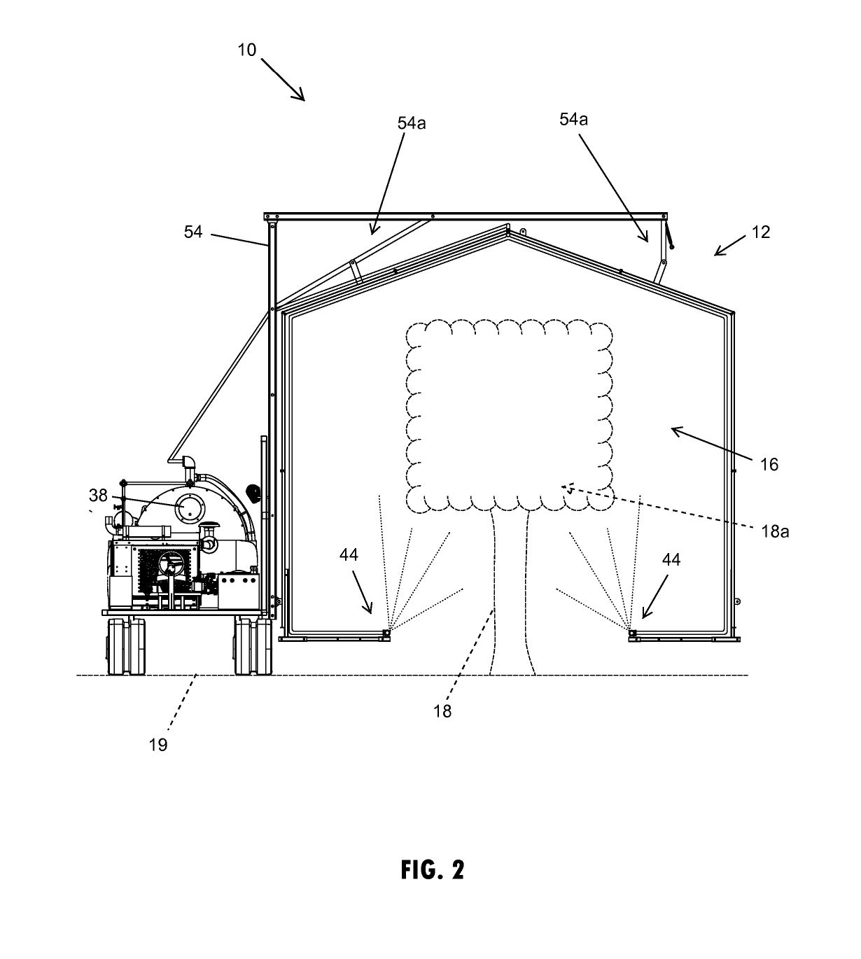

Referring now to the drawings and the illustrative embodiments depicted therein, a movable heat or steam applicator 10 includes a heat containment structure 12, a heat source that is adapted to dispense energy that generates heat in the heat containment structure 12, and a drivetrain 14 for moving the heat containment structure 12 over a ground surface. The heat containment structure 12 may define a cavity 16 sized or otherwise configured to at least partially enclose a tree, such as a citrus tree 18 (FIG. 2), or other living fruit-bearing plant. Accordingly, the heat containment structure 12 may at least partially encloses a citrus tree that may be infected with a bacterial disease, such as Huanglongbing (HLB), allowing the heat applicator 10 to treat the tree with thermotherapy, which involves exposing the tree to elevated temperature and/or humidity levels relative to the ambient air outside of to the heat containment structure 12. To avoid reduced humidity levels in the heat containment structure 12 that can have detrimental effects to the health of the tree and its fruit, such as drying or wilting, the generated heat may include the application of steam to raise the temperature around the tree in the heat containment structure 12. Steam also may be used due to its high heat capacity that can increase the heat transfer rate to the tree. The steam may be controlled or otherwise regulated by a control system to control the temperature and/or humidity in the heat containment structure 12 and other desired condition for the tree, and thereby create a desirable treatment environment that reduces or otherwise treats the bacterial disease. However, it is contemplated that in addition or in the alternative to the steam, the heat may be generated by dispensed energy from a different heat source, for example, by radiant energy, such as microwave or infrared radiation, by electrical resistance heating, and/or by fuel combustion, such as petroleum, ethanol, natural gas, propane, butane, and the like. The application of heat to the infected tree effectively kills or diminishes bacteria causing HLB and may combat other disease variations. The movable heat applicator 10 may also include an independent motor driven support vehicle 20 with the drivetrain 14 that independently carries the steam equipment and moves the containment structure 12 relative to the citrus tree, such as between trees in a grove having a plurality of trees 18 generally spaced from each other in rows. It is contemplated that a control system may also or alternatively operate the drivetrain 14 to control the position of the containment structure 12 relative to the ground surface based on a desired characteristic of the treatment environment.

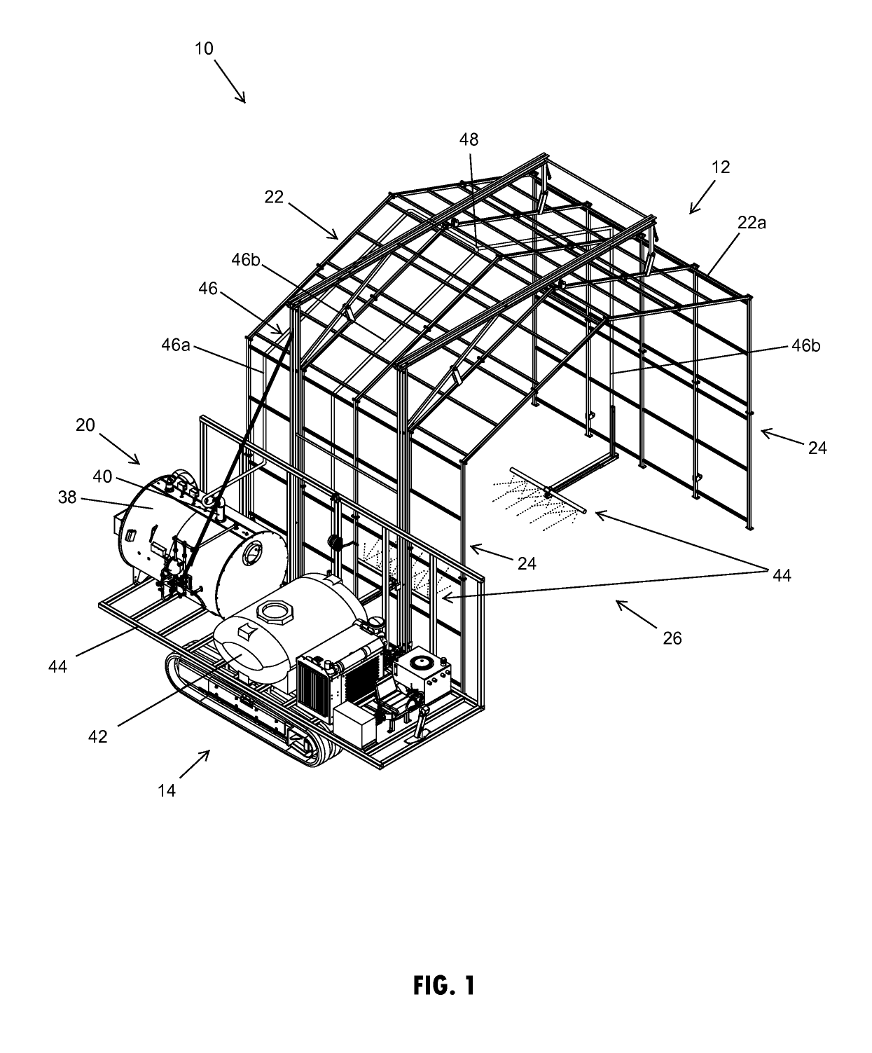

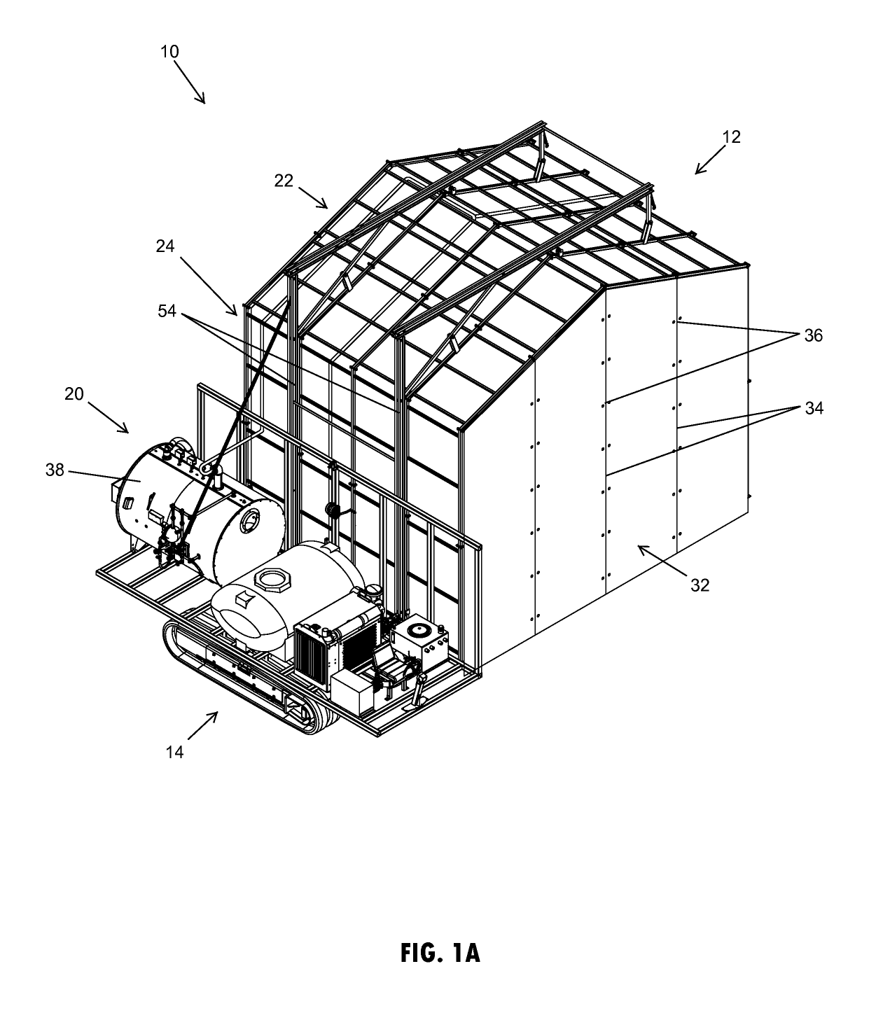

The heat containment structure 12 has a top cover 22 that is configured to span over an upper portion the citrus tree. The top cover 22 as shown in FIG. 1 also includes a gable shaped peak that is angled to shape the cavity in a manner that conforms to the a commonly shaped citrus tree, as typically trimmed or hedged, while limiting the interior volume of the containment structure 12 for improving heating efficiency. The heat containment structure 12 also includes one or more sidewalls 24, such as two opposing sidewalls 24 (FIG. 1), coupled with the top cover 22 for substantially enclosing the respective side portions of the citrus tree. The containment structure 12 is generally sized to substantially enclose at least one citrus tree, for example, the containment structure 12 may be 10-20 feet wide, 10-18 feet tall, and 15-20 feet long. The heat containment structure 12 may be adjustable to increase or decrease an enclosed volume of the heat containment structure 12. For example, the heat containment structure 12 may be expandable in length, width, and/or height to accommodate different tree sizes, multiple trees, and/or reduce the volume to eliminate portions unoccupied by the tree. It is contemplated that the containment structure 12 may be modified in size with extension mechanisms, such as roller-bearing guide rails to extend the length of the containment structure 12, and that the heat applicator 10 may include a height adjusting mechanism, such as a hydraulic or pneumatic system, for raising and lowering the containment structure 12 relative to the ground surface 19. For example, the height adjusting mechanism may be used to raise the containment structure 12 above obstacles on the ground, allow taller trees to enter the containment structure 12, and/or to adjust air circulation and intake conditions between the ground and the sidewalls 24. Also, the containment structure may be modified by gathering, stretching, or otherwise altering flexible fabric panels that hang from the framework of the containment structure 12.

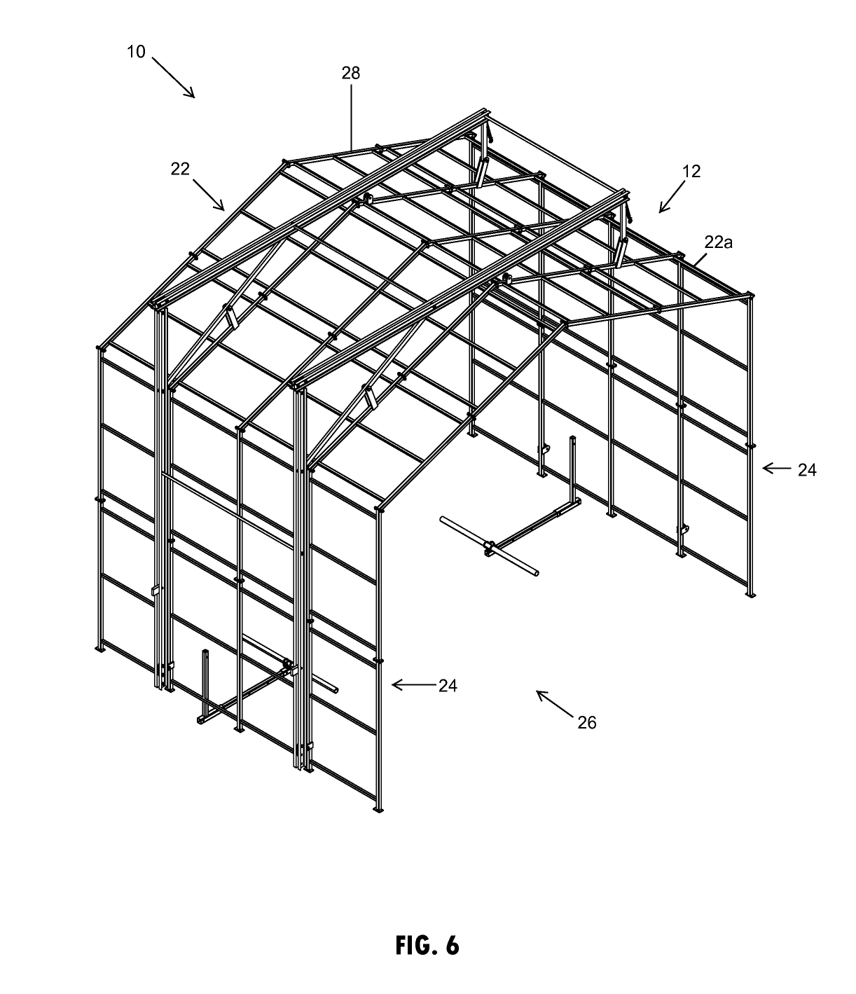

As shown in FIGS. 1 and 2, the sidewalls 24 of the heat containment structure 12 are coupled with a perimeter portion 22a of the top cover 22 and extend down from opposing sides of the top cover 22 to substantially enclose opposing side portions of the citrus tree. The heat containment structure 12, as shown, includes a rigid structural frame 28 (FIG. 6) and one or more panel members 30 (FIG. 1A) supported by the structural frame 28 and spanning the area of the top cover 22 or wall 24 or the like to form a substantially impermeable barrier. The frame 28 may be formed of metal, such as steel. It is contemplated that that frame may be reduced or illuminated in areas, such as at the sidewalls 24, should the heat source (such as steam conduit 46b) be modified, alternatively supported, or otherwise removed from the depicted embodiment. In such a situation, the panels 30 may independently hang down from the top cover 22 to define a sidewall 24. The panels 30 may be formed of any suitable material and combinations thereof, such as be a flexible material, a canvass or polymer sheet, and/or an impregnated fabric, such as Herculite® agricultural curtain, or the like, or a substantially rigid material, for example a fiber or foam synthetic board, plastic, vinyl, or metal, such as aluminum. The panels may thereby be substantially impermeable, provide insulation, and form the interior and/or exterior wall surface of the containment structure 12 to substantially retain heat and moisture therein. The panels may also be opaque to more efficiently absorb solar radiation or may be translucent to increase a greenhouse effect in the containment structure 12. It is contemplated that the heat containment structure may optionally have different shapes, such as an elongated U-shape, domed shape, or cylindrical shape, or be constructed without a separate frame structure, such as from an integral polymer material that forms the enclosure.

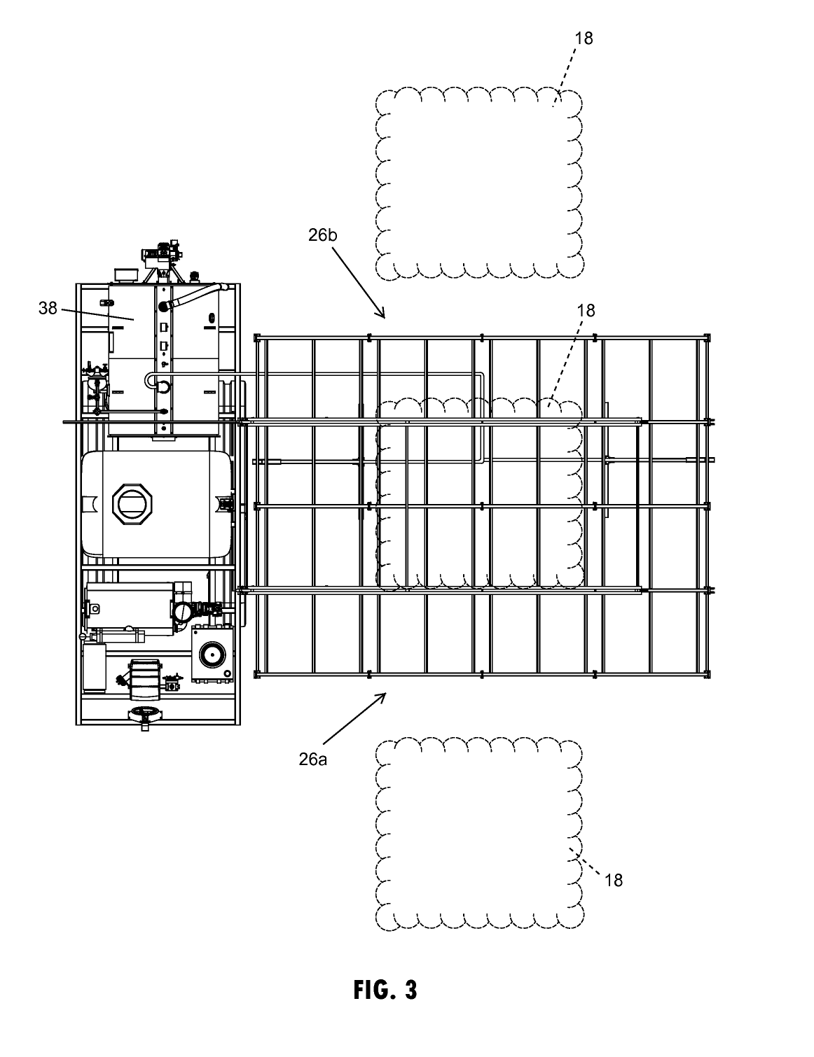

With continued reference to the heat containment structure 12, the cavity 16 may be elongated in the direction of travel of the heat applicator 10, such that the top cover 22 and sidewall 24 form a tunnel 26. As shown in FIG. 3, a front end opening 26a of the tunnel 26 is configured to receive a citrus tree 18 upon movement of the containment structure 12, such as with the drivetrain 14. Likewise, a rear end opening 26b of the tunnel 26 is configured in-line with the font end opening 26a, such that the containment structure may be moved in one general direction, for example along a row of trees, and the citrus tree 18 will exit the tunnel 26 through the rear end opening 26b.

As shown in FIG. 1A, the heat containment structure may also include at least one door 32 to enclose the front and rear end openings to improve efficiency of the heat applicator 10 by retaining heat in the tunnel 26. Accordingly, a door 32 may be provided to open when receiving a tree through the front end opening 26a and, upon positioning the heat containment structure 12 over a citrus tree, the door may close to at least partially enclose the front end opening 26a. Similarly a door 32 may be provided over the rear end opening 26b that may be opened when the treatment process is complete and the tunnel is moved forward to allow the tree to exit the cavity. As such, the heat containment structure 12 may include at least one door that is movable and enclosable to retain steam that is dispensed into the heat containment structure 12. As shown in FIG. 1A, the door 32 includes a slatted sheet or panel or series of panels separated by open seams 34. The seams 34 may be temporarily closed with detachable fasteners 36, such as magnets, hook-and-loop type fasteners, Velcro®, and other fasteners that have a releasable connection when the slats or panels are moved relative to each other, such as when a tree contacts the panels of the door 32 for entering or exiting the heat containment structure 12. The doors, for example, may be useful in colder seasons. It is also contemplated that the door or doors may be optionally be hinged to pivot opened and closed, may be rolled opened and closed, or may be of any other suitable configuration.

Optionally, a doors 32 or sidewall 24, or other portion of the heat containment structure 12 may include or entirely comprise an air door or air knife or air curtain or the like, such as a continuous broad stream of air that reaches the ground and moves with a velocity and at an angle that prevents ambient air from penetrating the stream of air, which thereby may act to at least partially retain the steam in the containment structure 12. Stated differently, an air agitation unit may be operable to generate an air curtain that includes a directionally-controlled airstream that moves across the entire height and width of a portion of the containment structure 12, such as acting as the door 32 or sidewall 24 of the containment structure 12, which reduces the transfer of air from one side of the air curtain to the other.

The depicted steam system of the movable heat applicator 10 includes a steam generator 38 adapted to produce steam and release the steam from an outlet 40 thereon at a desired pressure and temperature for treating the citrus tree 18. According to one embodiment, the steam generator 38 may produce steam at 225-275° F. at 10-20 PSI. For example, the steam generator 38 may produce steam at 250° F. at 15 PSI. The steam generator 38 may be of any suitable type and may include or connect in any manner to a water tank, reservoir, or container 42. As shown in FIG. 1, the water container 42 is carried alongside the steam generator 38 by a chassis 44 of the independent motor driven support vehicle 20, such that the steam generator 38 may move contemporaneously with the heat containment structure 12, such as to provide continuous movement of the heat applicator 10 and continuous treatment along a row of trees in a grove. However, a hose from a different water source, such as an irrigation system, may be attached to the steam generator 38 to illuminate the need for a water container 42 to provide substantially continuous operation in a grove.

As shown, the heat source used to generate heat in the heat containment structure 12 includes a steam distribution system 42 that is also provided on the movable heat applicator 10 to distribute the steam generated by the steam generator 38 to the treatment environment of the tree. The steam distribution system 42 includes a steam dispenser 44 that may be arranged in the cavity 16 of the containment structure 12, such as on an interior side of a sidewall 24, and positioned to dispense steam below branches 18a of the citrus tree 18 (FIG. 2). The steam distribution system also includes a conduit 46 connected between the outlet 40 of the steam generator 38 and the steam dispenser 44 for delivering the steam produced by the steam generator 38 to the steam dispenser 44. The steam is dispensed into the heat containment structure 12 and at least partially retained by the top cover 22 and sidewalls 24 to create a steam heated treatment environment for at least a portion of the citrus tree to reduce, kill, or otherwise treat the bacterial disease. To control the amount of steam flowing to the steam dispenser 44 and into the heat containment structure 12, the steam distribution system may include valves and/or baffles at the steam generator 38, along the conduit 46, or at each steam dispenser 44, which may be manually controlled and/or automatically operated by a control system. The conduit 46 may be formed from metal, such as stainless steel or copper, polymer, or other suitable material, and may include piping, hoses, or a combination thereof to direct the steam to the dispensers 44.

As shown in FIG. 1, the conduit 46 includes a first section 46a that couples with the outlet and extends up the adjacent sidewall 24 to split 48 at the peak of the top cover 22. A pair of second sections 46b of the conduit extend from the split 48 to the dispensers 44. The split 48 is positioned so that the second sections 46b of the conduit 46 have a substantially equal length to provide generally equivalent steam pressure at the dispensers 44 during operation. Optionally, the conduit 46 and the sections thereof may have different lengths extending to various dispenser arrangements in additional embodiments of the movable heat applicator 10. Further, it is contemplated that the conduit 46 may optionally have different diameters to balance the pressure and temperature of the steam at the dispensers, such as running a 3 inch diameter section of the conduit to the far side of the structure and a 2 inch diameter to the near side of the structure, such as when the sections of conduit are not equal in length.

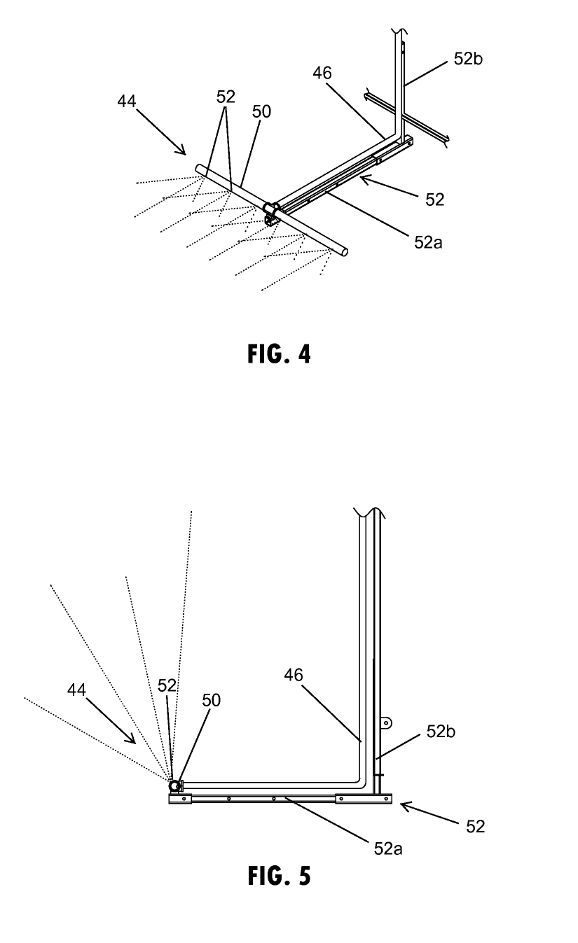

As shown in FIGS. 4 and 5, the steam dispensers 44 comprise a manifold 50 connected to the conduit 46 and having a plurality of openings 52 for releasing steam delivered via the conduit 46 of the steam distribution system. The openings 52 are generally directed upward and toward the tree. Optionally, the dispensers 44 may comprise a nozzle with a single opening aimed to dispense steam beneath the branches of the tree 18. To direct the steam into the containment structure 10 in a desirable manner that does not burn or otherwise harm the tree, it is also contemplated that the opening or openings of the dispenser 44 may be aimed or otherwise pointed upward, downward, and/or horizontally to direct the steam at the ground, at the trunk of the tree, at the base of the tree, or any other suitable location, while efficiently transferring heat to the tree in a way that reduces, kills, or otherwise treats the bacterial disease. The steam dispenser 44 may also include or otherwise be mounted to an adjustable support arm 52 that is configured to adjustably position the steam dispenser 44 beneath the branches of the tree, such that the steam is delivered at a desired proximity to the leaves and fruit of the tree. More specifically, the adjustable support arm 52 may have an L-shape with a lower portion 52a having a linear adjustment device, such as a rode and sleeve arrangement (FIGS. 4-5) or a track arrangement or the like, for movably adjusting the steam dispenser 44 in a generally horizontal plane. An upper portion 52b of the adjustable support arm 52 may also be provided with a linear adjustment device for movably adjusting the steam dispenser 44 in a vertical direction. It is also conceivable that the adjustable support arm 52 may be flexibly deformable, pivotal, or otherwise adjustable.

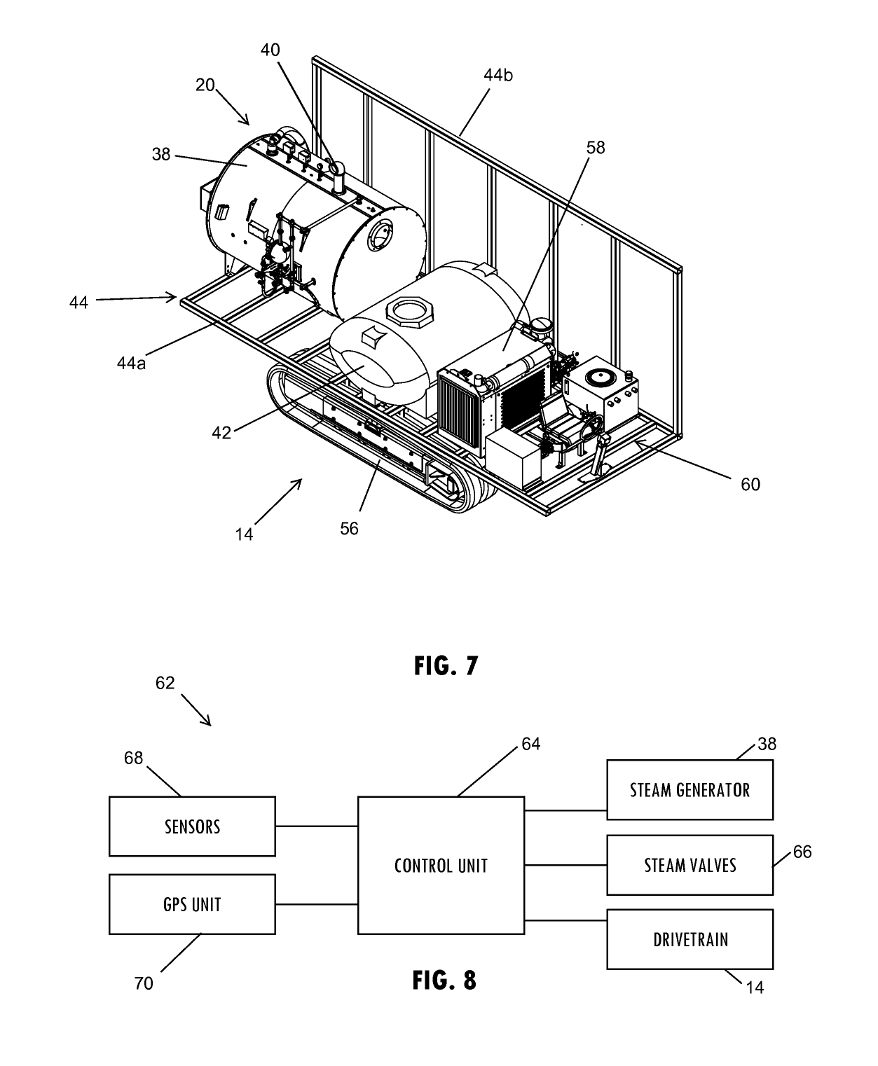

The movable heat applicator 10 may also include a chassis 44 coupled with the heat containment structure 12 and a drivetrain 14 that supports the chassis 44 for moving the heat containment structure 12 over a ground surface 19 (FIG. 2). The motor driven support vehicle 20 of the movable heat applicator 10, as shown in FIG. 7, provides the chassis 44 with a horizontal platform portion 44a for supporting the steam equipment, including the steam generator 38 and water container 42. The chassis 44 also has an upright support portion 44b that supports the containment structure 12. The specifically, the upright support portion 44b is mounted to support beams 54 (FIG. 1A) that extend upward along the adjacent sidewall and partially over the top cover 24 of the containment structure 12. The support beams 54 may include linkage arrangements 54a (FIG. 2) that attach between the support beams 54 and the structural portion of the top cover 24, such that small movements of the containment structure 12 may be permitted relative to the support beams 54 to prevent jarring at the chassis 44 of the vehicle 20. It is also contemplated that the support beams may rigidly attach to the containment structure or be integrally formed therewith.

With respect to the drivetrain 14, as shown in FIG. 7, it may be mounted on the chassis to independently carry the steam equipment and operable to move and position the containment structure 12 relative to the citrus tree, such as between trees in a citrus grove. The drivetrain 14 may, for example, include at least one driven wheel that rotates continuous tracks 56, which may be suitable to traverse bumps and sandy soil that may be found in citrus groves. In the alternative to, or in addition to, the continuous tracks 56, the drivetrain 14 may include at least one driven wheel that rotates a tire or the like for moving the heat applicator 10 through the grove. The drivetrain 14 may also include an engine 58 for driving the continuous tracks 36 through at least one driving wheel, and thereby move the chassis 22 and the heat containment structure 12 over the ground surface 19. The engine 58 may be one or a combination of an internal combustion engine and an electric engine, and as such, for example, may be a diesel powered engine that uses the same fuel oil, such as diesel gasoline, that is used by the steam generator 38.

The heat applicator 10 may also include a cockpit 60 for an operator. The cockpit 60, as shown in FIG. 7, is supported by the chassis 44 at the forward portion of the horizontal platform portion 44a. The cockpit 60 may house controls for moving, steering, and operating the heat applicator 10. Also, the cockpit 60 may contain hardware for operating the control system 62, such as the control unit 64 or components thereof. Optionally, components of the control system 62 may additionally or alternatively be located remotely from the chassis 44 or heat containment structure 12 of the heat applicator 10. As shown in FIG. 8, the cockpit 160 may also be enclosed to retain conditioned air and/or to protect the occupant from the elements.

Operating the heat applicator 10 may be done manually by manually adjusting the steam generator 38 and the steam distribution system, such as the valves and position of the steam dispenser 44, to create a desired treatment environment inside the containment structure 12 for treating the respective tree. In addition, or in the alternative, the heat applicator 10 may have some components that are automatically operated with a control system 62, such as controlling the amount of steam and the temperature in the cavity of the heat containment structure 12 based on one or more sensors 68 and/or a global positioning satellite (GPS) unit 70 in communication with the control unit 64.

The control system 62, as shown in FIG. 8, may for example, include a control unit 64, such as a computer, microprocessor, memory, and the like. The control unit 64 may include a microprocessor and/or other analog and/or digital circuitry for processing one or more routines or algorithms to operate the heat applicator 10 in a desirable manner. Additionally, the control unit 64 may include memory for storing one or more routines or algorithms or the like, including a data acquisition system or algorithm for storing historical treatment data, crop performance data, disease condition data, applicator operational data, and other data that may be analyzed and processed, such as by the control unit 64, to operate the heat applicator 10 and adjust desired treatment conditions and treatment methods. It should be appreciated that the control unit 64 may be a standalone dedicated control unit, multiple separate control units, or may be a shared control unit integrated with other control functions, such as integrated with one or more of the sensors 68 or the GPS unit 70, to process the output from sensors 68, output from the GPS unit 70, conditions of the steam valves 66 and steam generator 38, user inputs, and other inputs and perform related functionality. The control unit 64 may be in communication with the steam generator 38 for controlling the generation of steam, and/or in communication with the steam dispensers 44, and/or in communication with the valves and/or baffles at the steam generator 38, along the conduit 46, or at each steam dispenser 44 for controlling the amount of steam expelled from the steam dispensers 44 into the steam containment structure 12. Also, the control system 62 may be configured to control the drivetrain 14 to move the containment structure 12 relative to the citrus tree, based on a desired characteristic of the treatment environment. For example, the control system 62 may reduce or stop steam flow or adjust the speed of the containment structure 12 based on the temperature and/or humidity within the heat containment structure 12 and/or the elapsed time in which the tree has been exposed to the desired temperature within the heat containment structure 12. Accordingly, the movable heat applicator may include a temperature and/or humidity sensor inside and/or outside the containment structure 12, for respectively sensing the inside temperature and/or humidity and the outside temperature and/or humidity for use in controlling the heat applicator 10. Also, the movable heat applicator 10 may include a speed sensor and/or a timer for use by the control unit 64. In another example, a plurality of temperature sensors may be mounted in various zones of the tunnel 12 for measuring the temperature of the respective zone. In addition, the control system 62 may include sensors for measuring engine RPM (fuel consumption), power hub speed sensors for measuring ground speed, steam pressure and steam temperature sensors, and other operational related sensors. The location, temperature measurements, timing and/or any other measurement may also be used to analyze the success of steam treatment and correlate fruit yield.

With further reference to FIG. 8, the control system 40 may include the GPS unit 46 for tracking the location of the heat applicator 10. The control unit 64 may record locations of the heat applicator 10 with a date-time stamp and may record the measurements from the sensors 68, such as the temperature sensor, at given locations. The control system 62 may then be configured to automatically adjust the valves of the steam system based on recorded treatment history for specific trees, measurements from the sensors 68, and/or other recorded measurements based on location information from the GPS unit 70.

The control system 62 may also be configured to provide an alert, e.g., an audible or visual feedback, indicating of the treatment conditions are not suitable. For example an alert may identify to the operator that conditions in the heat containment structure 12 are not suitable to kill bacteria associated with HLB, such as a low temperature. As another example, an alert may identify to the operator that conditions in the heat containment structure 12 are harmful to the tree 18 in the heat containment structure 12, such as high temperatures or low humidity.

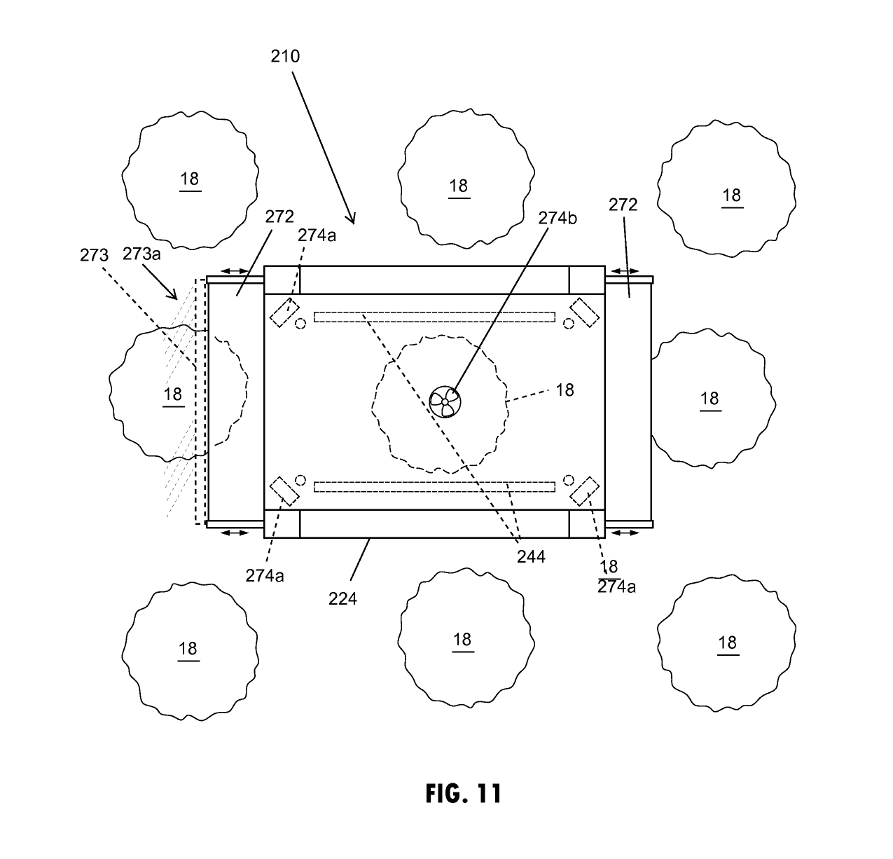

In addition to the heat generated in the containment structure by the heat source (i.e. the steam system), it is contemplated that the heat applicator, as shown in FIG. 11, may include a pre-heating energy dispenser 273 to dispense energy 273a (such as heat in the form of steam, hot water, hot air, radiant energy, and the like) at the tree to pre-heat all or a portion of the citrus tree before it is exposed to the treatment environment in the cavity of the containment structure. In this embodiment, the pre-heating energy dispenser 273 extends across the tunnel and is attached to a forward portion of the heat containment structure, such that hot water from the steam generator may be dispensed onto the tree before or while the tree enters the heat containment structure. This pre-heating step may allow the time of the tree in the treatment environment to be reduced, and accordingly, the heat applicator may move at a faster speed, such as through the rows of a grove.

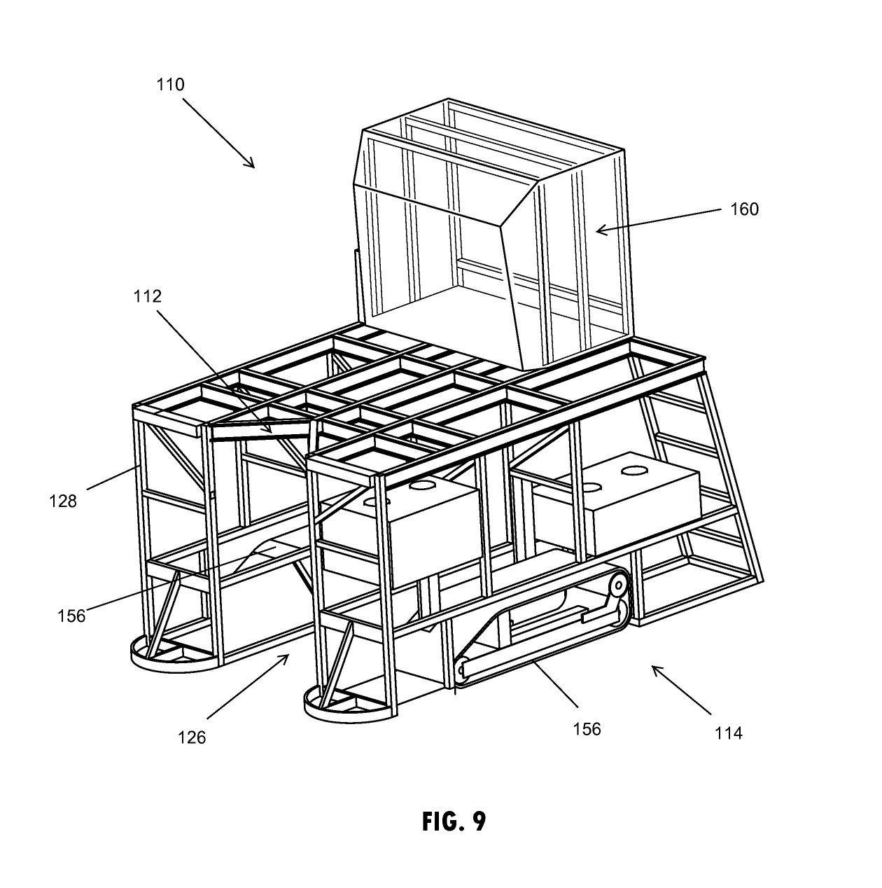

With reference to the illustrated embodiments of the heat applicator 110 shown in FIG. 9, the cockpit 160 is positioned above the heat containment structure 112 at a rear portion thereof. In this arrangement, the structural frame 128 of the heat containment structure 112 includes framework that supports the cockpit 160, as well as the drivetrain 114 and the steam generation and distribution system. The drive train 114, as shown, includes two sets of continuous tracks 156 for moving the heat containment structure 114 and the associate tunnel 126 over the ground surface to position a tree in the heat containment structure 114.

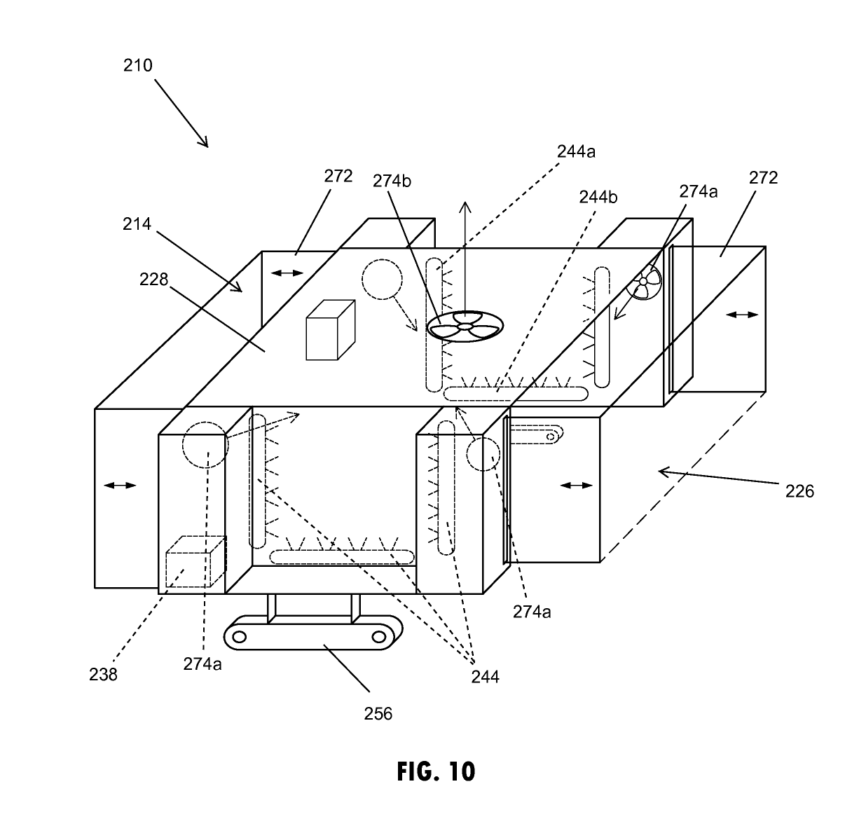

With reference to the illustrated embodiments of the heat applicator 210 shown in FIG. 10, the steam system includes a steam generator 238 for generating steam and a plurality of steam dispensers 244 shown as manifolds for directing the steam into the tunnel 226 for treating a tree. The manifolds include, for example, side manifolds 244a and lower manifolds 244b. The side manifolds 244a may be directed inwardly into the tunnel 226 and the lower manifolds 244b may be directed upwardly into the tunnel 226, as shown in FIG. 10. Specifically, each of the steam dispensers 244 may include a plurality of holes and/or nozzles for dispensing the steam into the tunnel 226 and the holes and/or nozzles may be positioned in any suitable direction to apply the steam to the tree. The steam dispensers 244 are supported by the structural frame 228, and for example, may be mounted to any suitable portion of the frame. The steam dispensers 244 may be formed of any suitable material such as stainless steel, copper, etc. The steam system may include any suitable number of steam dispensers 244 in any suitable position.

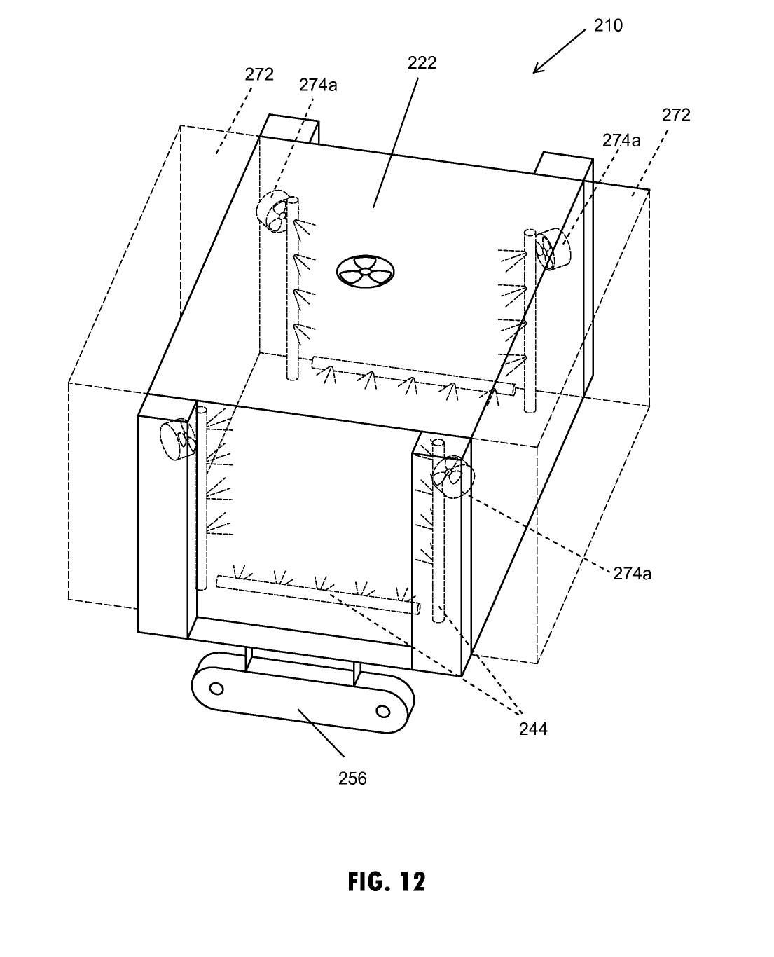

With reference to FIGS. 10-12, the frame 228 may include retractable sides 272 on one or both of a front end and a rear end of the heat applicator 210. The retractable sides 272 may be extended to lengthen the heat containment structure 214 during application of steam to the trees of the grove and may be retracted to shorten the heat containment structure 214 for transportation and storage. Further, the retractable sides 272 may be extended to cover more than one tree with the containment structure, such as along a row in a grove, as shown in FIG. 11. These retractable sides 272 may be U-shaped, gable shaped, or otherwise configured to extend the sides and the top of the heat containment structure 214, as shown in FIGS. 10 and 11. The retractable sides 272 may be formed of any suitable material. For example the retractable sides 272 may include jointed metal panels that retract in an accordion-like configuration. As another example, the retractable sides 272 may include plastic or vinyl sheets that may fold when retracted. The retractable sides 272 may be manually retracted and extended and/or may be automatically retracted and extended, e.g., motorized. The retractable sides 272 may each be 5-10 feet when extended to extend the length of the cavity 226.

The heat applicator 210 may include one or more air agitation units for suitably mixing the air and steam in the heat containment structure 214 around the tree to ensure that an adequate amount of steam for an adequate period of time is applied to the tree in the heat containment structure 214. For example, the heat applicator 210 may include a plurality of fans 274 for agitating the air and steam in the containment structure 214. The fans may be of any suitable type. Specifically, the heat applicator 210 may include one or more interior fans 274a for circulating air inside the tunnel 226 and/or one or more exterior fans 274b to intake or exhaust air from the tunnel 226. For example, as shown in FIG. 10, the heat applicator 210 includes four interior fans 274a, one at each corner of the tunnel 226, directed inwardly toward the tree to circular air in the tunnel 226. The interior fans 274a may each be in front of or behind one steam dispenser 244 for blowing air across the steam dispenser 244 8 inwardly into the tunnel 226. Also an air agitation unit may comprise an exterior fan 274b that communicates between the tunnel 226 and an exterior or ambient air. For example, at least one exterior fan 274b may be mounted to the sidewall 224 and/or the top cover 222 for drawing air and/or steam through the sidewall 224 and/or top cover 222. Specifically, as illustrated, an exterior fan 274b may be mounted to the center of the top cover 222 for drawing air and steam upwardly. This may pull the steam from the steam dispensers 244 upwardly through the branches and leaves of the tree.

The heat applicators 110 and 210 may otherwise be similar to the heat applicator 10, discussed above, such that a detailed discussion of the heat applicators need not be repeated herein.

A method for releasing steam in the movable containment structure 12 to treat a citrus tree 18 for a bacterial disease may include moving the heat applicator 10 over a citrus tree 18 to house the citrus tree 18 in the tunnel 26 and exposing the tree 18 to air in the tunnel 26 that is elevated in temperature and humidity compared to the ambient air outside the containment structure 12 for a select period of time, such as 10-45 seconds, and more preferably about 30 seconds. The method partially encloses the cavity sized to receive a citrus tree with the movable containment structure 12 that has the two opposing sidewalls 24 and the top cover 22 that is adapted to substantially prevent steam from exiting the cavity 16. Steam is generated at a desired temperature and pressure with the steam generator 38 that is movable with the movable containment structure 12. The steam that is generated by the steam generator 38 is distributed to a plurality of steam dispensers 44 in the cavity via a distribution conduit 46 that is at least partially supported by the movable containment structure 12. The steam delivered to the plurality of steam dispensers 44 is dispensed below branches of the citrus tree 18 for the steam to rise through the branches and at least partially be retained by the top cover 22. The amount of steam released to the cavity may be regulated to expose the citrus tree to a temperature greater than 130 degrees Fahrenheit for at least 30 seconds for diminishing or otherwise killing the bacterial disease on the citrus tree. For example, the method includes supplying steam at 225-275 degrees Fahrenheit at 10-20 PSI, and more specifically at 250 degrees Fahrenheit at 15 PSI, into the tunnel 26 to heat the air in the tunnel 26 to 130-140 degrees Fahrenheit.

In further reference to the method of operation, the heat applicator 10 may be operable to continuously move along the row of trees 18, such as through a grove. As one example, the heat applicator 10 may be moved at 60 feet per minute to expose the tree 18 to air that is around 130-140 degrees Fahrenheit in temperature for around 30-35 seconds. In the alternative to or in addition to continuous movement, the heat applicator 10 may be operable to index movement based on location of trees 18. In other words, the heat applicator 10 may be programmed to hover over each tree 18 for a longer period of time, without moving or with a slowed movement. For example, the heat applicator 10 may hover in colder seasons when additional heat is required to heat the air around the tree 16.

The method may also include recording data associated with the application of steam to the tree 18. For example, the temperature measurements from temperature sensors 68 of various zones of the tunnel 26 and the location of the heat applicator 10, e.g., GPS data, may be recorded along with a date-time stamp. This data may be stored for future use. For example, this data may be used to correlate treatment conditions with fruit yield in future years. As another example, this data may be used to confirm that harmful conditions were not applied to a tree 18 that later dies, i.e., a tree that dies of unrelated causes.

The method set forth above may be continuously applied as the heat applicator 10 is moved through the grove. For example data may be continuously recorded to record a continuous record of tunnel 26 location, tunnel 26 temperature, and time for later use. The method of applying steam to a grove of citrus trees 16 may be repeated as necessary to alleviate the bacterial disease, such as every two years.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

It will also be understood that any described processes or steps within described processes may be combined with other disclosed processes or steps to form structures within the scope of the present invention. The exemplary structures and processes disclosed herein are for illustrative purposes and are not to be construed as limiting.

Changes and modifications in the specifically described embodiments may be carried out without departing from the principles of the present invention, which is intended to be limited only by the scope of the following claims, as interpreted according to the principles of patent law.

1. A movable heat applicator for providing thermotherapy that is configured to treat a citrus tree for a bacterial disease, said movable heat applicator comprising:
a chassis attached to a drivetrain having at least one driven wheel that is operable to move the chassis over a ground surface;
a heat containment structure coupled with and supported by the chassis, the heat containment structure having a top cover and at least one sidewall that together define a cavity sized to at least partially enclose the citrus tree;
a heat source having an energy dispenser directed into the cavity of the heat containment structure and operable to dispense energy that creates a treatment environment for reducing bacteria on at least a portion of the citrus tree; and
a control system configured to control at least one of (i) the energy dispensed by the energy dispenser and (ii) movement of the containment structure relative to the ground surface via the drivetrain, based on a desired characteristic of the treatment environment.

2. The movable heat applicator of claim 1, wherein the desired characteristic of the treatment environment includes an elevated temperature greater than an ambient temperature outside the heat containment structure.

3. The movable heat applicator of claim 1, wherein the desired characteristic of the treatment environment includes substantially continuous movement of the containment structure over the citrus tree at a speed that exposes the citrus tree to the treatment environment for a select period of time.

4. The movable heat applicator of claim 1, wherein the desired characteristic of the treatment environment is monitored by at least one of (i) a temperature sensor, (ii) a humidity sensor, (iii) a speed sensor, and (iv) a timer.

5. The movable heat applicator of claim 1, wherein the control system includes a data acquisition system that is configured to record in a memory unit at least one of a temperature, a treatment duration, and a location for each tree that occupies the cavity of the containment structure.

6. The movable heat applicator of claim 1, wherein the heat source includes a steam generator supported by the chassis and having an outlet operable to release steam at a desired temperature and pressure for treating the citrus tree.

7. The movable heat applicator of claim 1, wherein the energy dispenser includes a steam distribution system having (i) a steam dispenser arranged in the cavity and positioned to dispense steam beneath branches of the citrus tree and (ii) a conduit connecting between a steam generator and the steam dispenser for delivering the steam produced by the steam generator to the steam dispenser, and wherein the steam distribution system includes a valve that is movable to control the steam dispensed.

8. The movable heat applicator of claim 1, further comprising:
an air agitation unit attached to the heat containment structure and operable to at least one of (i) mix air in the cavity with heat generated by the energy dispensed by the energy dispenser (ii) release air out of the cavity, and (iii) retain air in the cavity.

9. The movable heat applicator of claim 1, further comprising:
a pre-heating energy dispenser coupled with a forward portion of the heat containment structure and operable to dispense energy that pre-heats the portion of the citrus tree before it is exposed to the treatment environment in the cavity of the containment structure.

10. The movable heat applicator of claim 1, wherein the heat containment structure is expandable to adjust a volume of the cavity occupied by the citrus tree.

11. The movable heat applicator of claim 1, wherein the heat containment structure includes sidewalls extending down from opposing sides of the top cover to provide a tunnel having front and rear end openings that allow the citrus tree to pass through the cavity of the containment structure, and wherein the heat containment structure includes a door at least partially enclosing the rear end opening to retain steam that is dispensed into the heat containment structure.

12. A movable heat applicator for providing thermotherapy that is configured to treat a citrus tree for a bacterial disease, said movable heat applicator comprising:
a heat containment structure having a top cover that is configured to span over an upper portion of the citrus tree and at least one sidewall coupled with the top cover for substantially enclosing a respective side portion of the citrus tree, wherein the heat containment structure is adjustable to increase or decrease an enclosed volume;
a movable chassis coupled with and supporting the heat containment structure over a ground surface; and
a heat source supported by the chassis and configured to generate heat in the enclosed volume of the heat containment structure and create a treatment environment for diminishing bacteria on at least a portion of the citrus tree, said treatment environment having temperature and humidity levels greater than ambient air outside the containment structure.

13. The movable heat applicator of claim 12, wherein the heat containment structure comprises a rigid structural frame and a substantially impermeable panel supported by the structural frame and extending down from opposing sides of the top cover to provide a tunnel with an expandable length extending between front and rear end openings of the tunnel.

14. The movable heat applicator of claim 13, wherein the heat containment structure includes a door at least partially enclosing one of the rear end opening and the front end opening to retain heat in the heat containment structure.

15. The movable heat applicator of claim 12, further comprising:
a control system configured to control the heat generated in the containment structure by the heat source based on a desired characteristic of the treatment environment that is monitored by at least one of (i) a temperature sensor, (ii) a humidity sensor, (iii) a speed sensor, and (iv) a timer.

16. The movable heat applicator of claim 15, wherein the desired characteristic of the treatment environment includes at least one of a temperature greater than 100 degrees Fahrenheit and exposure of the citrus tree to the treatment environment for at least 10 seconds.

17. The movable heat applicator of claim 12, wherein the heat source comprises a steam generator supported by the chassis and operable to deliver steam to a steam dispenser positioned to dispense steam beneath branches of the citrus tree.

18. The movable heat applicator of claim 12, wherein a drivetrain is coupled with the movable chassis and includes continuous tracks driven by an engine that is supported by the movable chassis, said drivetrain being operable to move the heat containment structure over the citrus tree at a substantially continuous speed.

19. A method for providing thermotherapy that is configured to treat a row of citrus trees in a grove for a bacterial disease, said method comprising:
at least partially enclosing a cavity sized to receive one or more citrus trees with a movable heat containment structure that has at least two opposing sidewalls and a top cover that is adapted to substantially prevent heat from exiting the cavity;
generating heat in the cavity of the heat containment structure with a movable heat source attached to the movable heat containment structure;
creating a treatment environment in the cavity with the heat generated by the movable heat source for diminishing bacteria on the citrus tree in the cavity, said treatment environment having temperature and humidity levels greater than ambient air outside the containment structure;
sensing conditions of the treatment environment with at least one of (i) a temperature sensor, (ii) a humidity sensor, and (iii) a speed sensor; and
controlling at least one of (i) energy dispensed to the cavity by the heat source, (ii) operation of an air agitation unit attached to the heat containment structure, (iii) operation of a pre-heating energy dispenser configured to pre-heat a portion of a citrus tree, and (iv) a speed of the containment structure relative to the ground surface, based on the sensed conditions of the treatment environment and a desired characteristic of the treatment environment.

20. The method of claim 19, wherein the desired characteristic of the treatment environment includes exposing each infected citrus tree in the row of citrus trees to an elevated temperature greater than an ambient temperature outside the heat containment structure for a select period of time, and wherein the movable heat source includes a steam generator that distributes steam to a plurality of steam dispensers in the cavity, and wherein at least one of the plurality of steam dispensers are positioned to dispense steam below branches of the citrus tree for the steam to rise through the branches and at least partially be retained by the top cover.
